(19) United States
(12) Patent Application Publication
(10) Pub. No.: US 2013/0070804 A1
(43) Pub. Date: Mar. 21, 2013

(54) METHOD FOR ESTIMATING AMBIENT AIR TEMPERATURE PRIOR TO COMBUSTION IN AN INTERNAL COMBUSTION ENGINE

(71) Applicants: Jeffery S. Hawkins, Farmington Hills, MI (US); Michael C. Salch, Lake Oswego, OR (US); Bryant C. Pham, Canton, MI (US); Kurt J. Couture, Farmington Hills, MI (US)

(72) Inventors: Jeffery S. Hawkins, Farmington Hills, MI (US); Michael C. Salch, Lake Oswego, OR (US); Bryant C. Pham, Canton, MI (US); Kurt J. Couture, Farmington Hills, MI (US)

(73) Assignee: Detroit Diesel Corporation, Detroit, MI (US)

(21) Appl. No.: 13/237,066

(22) Filed: Sep. 20, 2011

(51) Int. Cl. G01K 15/00

(52) U.S. Cl. 374/1; 374/E15.001

(57) ABSTRACT

A method to estimate ambient air temperature in the vicinity of a vehicle equipped with an internal combustion engine equipped with at least an ignition and an electronic control unit (ECU) with memory.

### TECHNICAL FIELD

Ambient air temperature information is useful for a variety of vehicle/equipment applications such as engine control and diagnostics, aftertreatment control and diagnostics, and complying with On Board Diagnostic (OBD) requirements such as monitor performance reporting and tracking Both OBD systems and Diesel Exhaust Filter (DEF) heating control systems are examples in which it is necessary to have fairly accurate ambient temperature information. It is difficult to accurately determine the ambient temperature in the vicinity surrounding a vehicle because the sensor is sensitive to environmental influences that can cause the sensor to indicate the ambient temperature is higher than the actual value. Environmental influences can come from a variety of sources including engine compartment heat, radiated heat from pavement, direct sunlight and many other sources.

There is a need for a method to enhance the accuracy of the ambient air temperature sensor measurements in order to avoid gross errors in determining the actual ambient temperature. In addition, there is a need to avoid some of the issues typically associated with physical measurement of the ambient temperature relative to environmental influences (engine compartment heat, fan status, direct sunlight, radiated heat from pavement, etc.,) that may cause higher the sensor measurement of the temperature to be higher than actual ambient temperature. Furthermore, there is a need for a method that takes into account any differences between the ambient air temperature and the physical ambient air temperature sensor measurement, which allows for quick drops in ambient temperature (i.e. vehicle is inside an environmentally controlled area) but has additional logic to limit the maximum temperature rise of the “calculated” ambient air temperature.

### SUMMARY OF THE INVENTION

In one embodiment, the present application relates to a method to more accurately determine the “true” ambient air temperature in the vicinity of a vehicle having with an internal combustion engine equipped with at least an ignition and an electronic control unit (ECU) with memory and a means for determining length of time the ignition is off or time engine is not running, vehicle speed information, charge air cooler outlet temperature and an ambient temperature by applying additional logic to the measurement information provided by a physical ambient temperature sensor.

The method may include determining whether an ignition off period is less than a calibratible minimum threshold period of time. The minimum threshold period of time value is stored in memory in the electronic control unit (ECU). The method further includes initializing an ambient air temperature value from either a last ambient air temperature value stored in memory or from the actual ambient temperature sensor value immediately after ignition is enabled, depending on the time since the last ignition off event. The initial ambient temperature may also be based upon an ambient temperature value stored in memory using one of two optional parameters. One initial ambient value may be based upon a determination of whether the period of time since the engine was last running is less than a predetermined calibratable threshold. Another initial ambient temperature value may be based on determining whether the charge air cooler outlet temperature is above a predetermined, calibratable minimum threshold. It is also contemplated that other temperatures such as, for example, intake manifold temperature, engine coolant temperature or engine oil temperature may also be used as an initial ambient temperature. It should be understood that the purpose of an initial ambient temperature is to determine if the engine is warm, which may possibly influence ambient temperature readings. In another embodiment, the charge air cooler outlet temperature may also be used as the initial ambient temperature.

The method also includes initializing an ambient temperature based upon the actual ambient temperature sensor measurement if the time since the engine was last running exceeds a predetermined calibratable threshold or if the charge air cooler outlet temperature is below a predetermined calibratible minimum threshold. In this regard, other temperatures such as, for example, intake manifold temperature, engine coolant temperature or engine oil temperature may also be used, as the purpose in this determination is to determine if the engine is warm, which may possibly influence ambient temperature readings. In another embodiment, the charge air cooler outlet temperature may also be used. The method also includes using the physical ambient temperature sensor value as the true ambient value if vehicle speed exceeds a threshold. The method may also include continually filtering and updating the true ambient value based on the physical ambient temperature sensor value for as long as vehicle speed exceeds a predetermined, calibratable threshold, and storing the last true ambient value determined above the minimum vehicle speed threshold once the vehicle speed no longer exceeds the vehicle speed threshold for a predetermined calibratable period of time. To assist in determining the vehicle speed threshold, vehicle speed may be determined by measuring wheel speed, road speed or transmission speed or in any other manner.

The method may also include utilizing the last estimated ambient air temperature as the ambient air temperature estimate if it is lower than the actual ambient air temperature; using additional filtering to slowly adjust the true ambient value once the calibratible time threshold below the minimum vehicle speed threshold has been exceed; and providing a calibratable option to adjust the determined “true” ambient temperature based on engine fan status. For example, for a unique vehicle application, an offset to the measured ambient temperature may be included based on engine fan status.

The method may further include using a one sided low pass filter that allows for quick drops in the “true” ambient determination to account for situations such as leaving a heated garage on a cold winter day, but limits ambient temperature increases when the ambient temperature sensor indicates values higher than the “true” ambient. The limit reduces errors in ambient temperature which may be induced by various environmental or operational factors (e.g. vehicle hot soak after engine is shut down). The filter constant may be based upon vehicle speed to compensate for heat soaks.

A more complete understanding of the methods of the present disclosure may be understood upon a consideration of the following description, drawings and the claims.

### BRIEF DESCRIPTION OF THE DRAWINGS

FIG. 1 is a schematic overview of an internal combustion engine system;

FIG. 2 is a schematic representation of one software flow diagram showing one method according to the present application;

FIG. 3 is a continuation of the schematic representation of a software flow diagram showing one method according to the present application.

### DETAILED DESCRIPTION

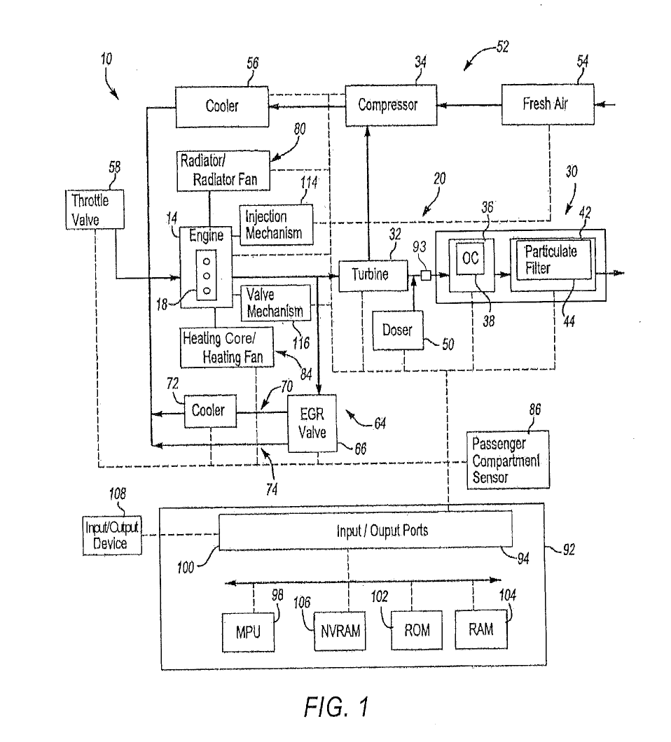

FIG. 1 illustrates a vehicle powertrain system 10 in accordance with one non-limiting aspect of the present invention. The system 10 may provide power for driving any number of vehicles, including on-highway trucks, construction equipment, marine vessels, stationary generators, automobiles, trucks, tractor-trailers, boats, recreational vehicle, light and heavy-duty work vehicles, and the like.

The system 10 may be referred to as an internal combustion driven system wherein fuels, such as gasoline and diesel fuels, are burned in a combustion process to provide power, such as with a compression ignition engine 14. The engine 14 may be a diesel engine that includes a number of cylinders 18 into which fuel and air are injected for ignition as one skilled in the art will appreciate. The engine 14 may be a multi-cylinder compression ignition internal combustion engine, such as a 4, 6, 8, 12, 16, or 24 cylinder diesel engines, for example.

Exhaust gases generated by the engine 14 during combustion may be emitted through an exhaust system 20. The exhaust system 20 may include any number of features, including an exhaust manifold and passageways to deliver the emitted exhaust gases to a particulate filter assembly 30, which in the case of diesel engines is commonly referred to as a diesel particulate filter. Optionally, the system 20 may include a turbocharger proximate the exhaust manifold for compressing fresh air delivery into the engine 14. The turbocharger, for example, may include a turbine 32 and a compressor 34, such as a variable geometry turbocharger (VGT) and/or a turbo compound power turbine. Of course, the present invention is not limited to exhaust systems having turbochargers or the like.

The particulate filter assembly 30 may be configured to capture particulates associated with the combustion process. In more detail, the particulate filter assembly 30 may include an oxidation catalyst (OC) canister 36, which in includes an OC 38, and a particulate filter canister 42, which includes a particulate filter 44. The canisters 36, 42 may be separate components joined together with a clamp or other feature such that the canisters 36, 42 may be separated for servicing and other operations. Of course, the present invention is not intended to be limited to this exemplary configuration for the particulate filter assembly 30. Rather, the present invention contemplates the particulate filter assembly including more or less of these components and features. In particular, the present invention contemplates the particulate filter assembly 30 including only the particulate filter 44 and not necessarily the OC canister 36 or substrate 38 and that the particulate filter 44 may be located in other portions of the exhaust system 20, such as upstream of the turbine 32.

The OC 38, which for diesel engines is commonly referred to as a diesel oxidation catalyst, may oxidize hydrocarbons and carbon monoxide included within the exhaust gases so as to increase temperatures at the particulate filter 44. The particulate filter 44 may capture particulates included within the exhaust gases, such as carbon, oil particles, ash, and the like, and regenerate the captured particulates if temperatures associated therewith are sufficiently high. In accordance with one non-limiting aspect of the present invention, one object of the particulate filter assembly 30 is to capture harmful carbonaceous particles included in the exhaust gases and to store these contaminates until temperatures at the particulate filter 44 favor oxidation of the captured particulates into a gas that can be discharged to the atmosphere.

The OC and particulate filter canisters 36, 42 may include inlets and outlets having defined cross-sectional areas with expansive portions therebetween to store the OC 38 and particulate filter 44, respectively. However, the present invention contemplates that the canisters 36, 42 and devices therein may include any number configurations and arrangements for oxidizing emissions and capturing particulates. As such, the present invention is not intended to be limited to any particular configuration for the particulate filter assembly 30.

To facilitate oxidizing the capture particulates, a doser 50 may be included to introduce fuel to the exhaust gases such that the fuel reacts with the OC 38 and combusts to increase temperatures at the particulate filter 44, such as to facilitate regeneration. For example, one non-limiting aspect of the present invention contemplates controlling the amount of fuel injected from the doser as a function of temperatures at the particulate filter 44 and other system parameters, such as air mass flow, EGR temperatures, and the like, so as to control regeneration. However, the present invention also contemplates that fuel may be included within the exhaust gases through other measures, such as by controlling the engine 14 to emit fuel with the exhaust gases.

An air intake system 52 may be included for delivering fresh air from a fresh air inlet 54 through an air passage to an intake manifold for introduction to the engine 14. In addition, the system 52 may include an air cooler or charge air cooler 56 to cool the fresh air after it is compressed by the compressor 34. Optionally, a throttle intake valve 58 may be provided to control the flow of fresh air to the engine 14. The throttle valve 58 may be an electrically operated valve. There are many variations possible for such an air intake system and the present invention is not intended to be limited to any particular arrangement. Rather, the present invention contemplates any number of features and devices for providing fresh air to the intake manifold and cylinders, including more or less of the foregoing features.

An exhaust gas recirculation (EGR) system 64 may be optionally provided to recycle exhaust gas to the engine 14 for mixture with the fresh air. The EGR system 64 may selectively introduce a metered portion of the exhaust gasses into the engine 14. The EGR system 64, for example, may dilute the incoming fuel charge and lower peak combustion temperatures to reduce the amount of oxides of nitrogen produced during combustion. The amount of exhaust gas to be re-circulated may be controlled by controlling an EGR valve 66 and/or in combination with other features, such as the turbocharger. The EGR valve 66 may be a variable flow valve that is electronically controlled. There are many possible configurations for the controllable EGR valve 66 and embodiments of the present invention are not limited to any particular structure for the EGR valve 66.

The EGR system 64 in one non-limiting aspect of the present invention may include an EGR cooler passage 70, which includes an air cooler 72, and an EGR non-cooler bypass 74. The EGR value 66 may be provided at the exhaust manifold to meter exhaust gas through one or both of the EGR cooler passage 70 and bypass 74. Of course, the present invention contemplates that the EGR system 64 may include more or less of these features and other features for recycling exhaust gas. Accordingly, the present invention is not intended to be limited to any one EGR system and contemplates the use of other such systems, including more or less of these features, such as an EGR system having only one of the EGR cooler passage or bypass.

A cooling system 80 may be included for cycling the engine 14 by cycling coolant therethrough. The coolant may be sufficient for fluidly conducting away heat generated by the engine 14, such as through a radiator. The radiator may include a number of fins through which the coolant flows to be cooled by air flow through an engine housing and/or generated by a radiator fan directed thereto as one skilled in the art will appreciated. It is contemplated, however, that the present invention may include more or less of these features in the cooling system 80 and the present invention is not intended to be limited to the exemplary cooling system described above.

The cooling system 80 may operate in conjunction with a heating system 84. The heating system 84 may include a heating cone, a heating fan, and a heater valve. The heating cone may receive heated coolant fluid from the engine 14 through the heater valve so that the heating fan, which may be electrically controllable by occupants in a passenger area or cab of a vehicle, may blow air warmed by the heating cone to the passengers. For example, the heating fan may be controllable at various speeds to control an amount of warmed air blown past the heating cone whereby the warmed air may then be distributed through a venting system to the occupants. Optionally, sensors and switches 86 may be included in the passenger area to control the heating demands of the occupants. The switches and sensors may include dial or digital switches for requesting heating and sensors for determining whether the requested heating demand was met. The present invention contemplates that more or less of these features may be included in the heating system and is not intended to be limited to the exemplary heating system described above.

An ECU 92, such as an electronic control module or engine control module, may be included in the system 10 to control various operations of the engine 14 and other system or subsystems associated therewith, such as the sensors in the exhaust, EGR, and intake systems. Various sensors may be in electrical communication with the controller via input/output ports 94. The ECU 92 may include a microprocessor unit (MPU) 98 in communication with various computer readable storage media via a data and control bus 100. The computer readable storage media may include any of a number of known devices which function as read only memory 102, random access memory 104, and non-volatile random access memory 106. A data, diagnostics, and programming input and output device 108 may also be selectively connected to the controller via a plug to exchange various information therebetween. The device 108 may be used to change values within the computer readable storage media, such as configuration settings, calibration variables, instructions for EGR, intake, and exhaust systems control and others.

The system 10 may include an injection mechanism 114 for controlling fuel and/or air injection for the cylinders 18. The injection mechanism 114 may be controlled by the ECU 92 or other controller and comprise any number of features, including features for injecting fuel and/or air into a common-rail cylinder intake and a unit that injects fuel and/or air into each cylinder individually. For example, the injection mechanism 114 may separately and independently control the fuel and/or air injected into each cylinder such that each cylinder may be separately and independently controlled to receive varying amounts of fuel and/or air or no fuel and/or air at all. Of course, the present invention contemplates that the injection mechanism 114 may include more or less of these features and is not intended to be limited to the features described above.

The system 10 may include a valve mechanism 116 for controlling valve timing of the cylinders 18, such as to control air flow into and exhaust flow out of the cylinders 18. The valve mechanism 116 may be controlled by the controller 92 or other controller and comprise any number of features, including features for selectively and independently opening and closing cylinder intake and/or exhaust valves. For example, the valve mechanism 116 may independently control the exhaust valve timing of each cylinder such that the exhaust and/or intake valves may be independently opened and closed at controllable intervals, such as with a compression brake. Of course, the present invention contemplates that the valve mechanism may include more or less of these features and is not intended to be limited to any of the features described above.

In operation, the ECU 92 receives signals from various engine/vehicle sensors and executes control logic embedded in hardware and/or software to control the system 10. The computer readable storage media may, for example, include instructions stored thereon that are executable by the ECU 92 to perform methods of controlling all features and sub-systems in the system 10. The program instructions may be executed by the ECU in the MPU 98 to control the various systems and subsystems of the engine and/or vehicle through the input/output ports 94. In general, the dashed lines shown in FIG. 1 illustrate the optional sensing and control communication between the ECU and the various components in the powertrain system. Furthermore, it is appreciated that any number of sensors and features may be associated with each feature in the system for monitoring and controlling the operation thereof.

In one non-limiting aspect of the present invention, the ECU 92 may be the DDEC controller available from Detroit Diesel Corporation, Detroit, Mich. Various other features of this controller are described in detail in a number of U.S. patents assigned to Detroit Diesel Corporation. Further, the ECU may include any of a number of programming and processing techniques or strategies to control any feature in the system 10. Moreover, the present application contemplates that the system may include more than one controller, such as separate controllers for controlling system or sub-systems, including an exhaust system controller to control exhaust gas temperatures, mass flow rates, and other features associated therewith. In addition, these controllers may include other controllers besides the DDEC controller described above.

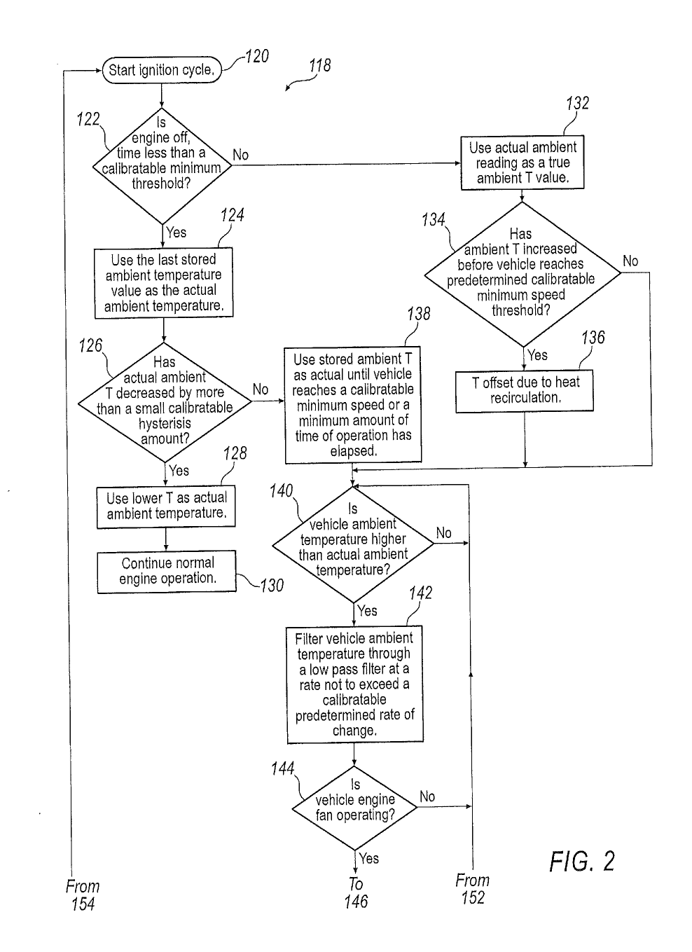

FIG. 2 is a software flowchart showing one method 118 according to one embodiment of the present application. Specifically step 120 is start the ignition cycle. In any ignition cycle, it is necessary to determine whether a hot soak or a cold soak will apply to the ignition cycle. This may be accomplished by either using the engine off timer or engine air temperature (intake cooler/temperature at the intake) to determine whether the engine is in hot soak or cold soak. The temperature at the engine air temperature is expected to cool at a rate more similar to ambient temperature than on do the engine liquid temperatures such as coolant. However, it is contemplated that engine liquid temperatures could be used, provided a suitable data filter was used.

Step 122 is determining whether the engine off time is less than a calibratible minimum threshold. By way of example, and assuming an engine off timer is used, engine off time elapse less than a calibratible predetermined minimum threshold period of time indicates an engine hot soak. Otherwise, the engine is in cold soak. The engine off time period may also be determined by determining the engine air temperature. When the engine air temperature is less than a calibratable minimum threshold, the engine is in cold soak. Otherwise, the engine is in hot soak. The hot soak condition indicates the engine off time is less than a calibratible minimum threshold. A cold soak condition indicates that the engine has been off for more than a claibratable minimum threshold.

If the determination in step 122 is “yes”, the software proceeds to step 124, and the ECU utilizes the last stored ambient temperature value in memory as the initialized ambient air temperature estimate at a point prior to a combustion chamber of the engine. This point may be at the turbo charger cooler outlet, the air manifold outlet, or any other air outlet of the engine. In addition, to avoid potential OBD compliance issues, it may be desirable to add a calibratible offset value to the initialized ambient temperature if it is below a predetermined calibratible value, such as, for example, 20° F.

The method then proceeds to step 126, which is determining whether the actual ambient temperature decreased by more than a predetermined, calibratable hysteresis amount. If the determination in step 126 is “yes”, the method utilizes the lower temperature as the actual ambient temperature at step 128, and normal engine operation continues at step 130.

If the determination in step 122 is “no” the method proceeds to step 132, which is to initialize the actual ambient air temperature as the true ambient temperature value. If the ambient temperature decreases, such for example, when the vehicle is moved from inside to outside, the lower actual ambient temperature value shall be considered as the actual ambient temperature. Step 132 also requires a determination whether the actual ambient temperature has increased before the vehicle reaches a predetermined, calibratable minimum speed threshold. It is assumed that there are no vehicle conditions that will cause the ambient temperature reading to be lower than the actual ambient temperature, but several factors may cause the ambient temperature to be perceived as higher than normal. It has been determined that ambient temperature data at higher vehicle speeds is more reliable than ambient temperature data taken when the vehicle is not moving. In addition, in order to avoid potential OBD compliance issues, it may be desirable to add a calibratible offset value to the initialized ambient temperature if it is below a predetermined calibratible value, such as, for example, 20° F.

If the determination in step 132 is “yes”, step 134 is apply an ambient temperature offset value through a calibratable filter or other means, to compensate for any heat recirculation cause by the vehicle operation. In addition to any standard low pass filter, the ambient temperature filter should be calibratable to provide the effect of not exceeding a maximum temperature decrease (° C./time). The filter can be one sided, and, if one sided, should allow a high (fast) temperature decrease., while not allowing for high temperature increase. If it is determined that the actual ambient air temperature is greater than the initialized ambient air temperature, the data can be passed through a low pass filter to provide for an incremental rise in the estimated ambient air temperature used by the vehicle engine for operation. The incremental rise in temperature may be determined by the algorithm:

y(n)=[1−filter constant]x(n)+filter constant Xy(n−1)

wherein the filter constant may be based upon vehicle speed to compensate for heat soaks, and heat soaks may be determined by measuring vehicle speed, by reference to wheel speed, road speed or transmission speed, or any other method to measure vehicle speed.

If the determination in step 126 is “no”, step 138 is using a stored ambient temperature as the actual ambient temperature until the vehicle reaches a predetermined, calibratable minimum threshold speed, or until a predetermined, calibratable minimum period of time of vehicle operation has elapsed.

If the determination in step 134 is “no”, the method then joins the flow from step 138, and the method proceeds to step 140, which is determining whether the vehicle ambient temperature is higher than the actual ambient temperature. If the determination in step 134 is “no” the software loops back to step 140, and the determination is repeated.

If the determination in step 140 is “yes”, the software proceeds to step 142, which is filter the vehicle ambient temperature through a low pass filter at a rate not to exceed a calibratable, predetermined rate of change. The software then proceeds to step 144, which is a determination whether the engine fan is operating. If the determination in step 144 is “no”, the software loops bask to step 140.

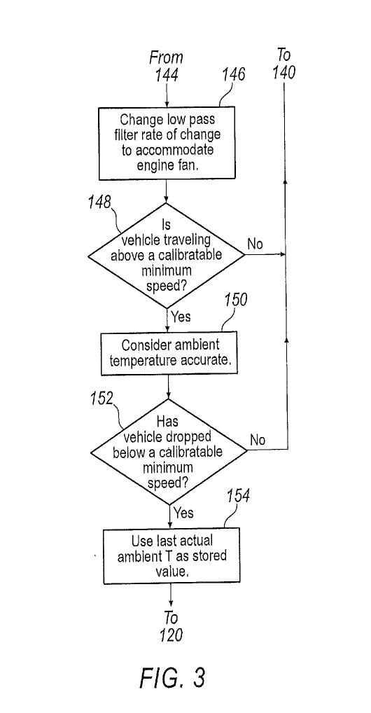

If the determination in step 144 is “yes”, and making reference to FIG. 3, step 146 is change the low filter pass filter rate of change to accommodate the engine fan. When the fan is on, it may have a significant adverse effect on the ambient temperature reading. Therefore, it may be a calibratable option to either change the filter rate or temporarily latch the reading. If the filter rate is used, the fan that remains on due to a sensor failure does not cause the ambient temperature reading to latch.

Step 148 is determining whether the vehicle is traveling above a predetermined, calibratable minimum vehicle speed (isp_min_veh_spd_true_ambient). If the determination is “yes”, then step 150 is consider the ambient air temperature to be the accurate, true temperature once a minimum stabilization time has occurred. Once an ambient temperature determination has been made above the minimum calibratible vehicle speed and time, that value is considered to be the true value regardless of any previous determinations made prior to exceeding the minimum vehicle speed threshold. The ambient temperature is continually updated whenever the vehicle is above the minimum vehicle speed threshold. The data may have additional filtering. If the determination in step 148 is “no”, the software loops back to step 140.

Returning to step 150, the software proceeds to step 152, which is determining whether the vehicle has dropped below a predetermined, calibratable minimum speed. If the determination is “yes”, then the software proceeds to step 154 and uses the last actual ambient temperature as the stored temperature value, and the software afterword loops back to step 120. Once the vehicle speed drops below the minimum vehicle speed threshold that last determined value for the true ambient is stored in memory. The true ambient temperature will remain the ambient temperature (unless the ambient temperature decreases, in which case the lower temperature shall be considered the true ambient) for a calibratible time (t_amb_vspd_hold_time). The calibratible timer is calibratible in minutes with a minimum range of 0 to 240 minutes and a minimum resolution of 15 minutes/bit. If the engine remains on and the vehicle speed remains below the minimum vehicle speed threshold for a time exceeding the calibratable vehicle speed hold time, the ambient temperature shall use moving towards the measured temperature through a slow filter (ambient temperature filter). The filter should be calibratiale to provide the effect of not exceeding a maximum rate of change (° C./time). If the determination in step 154 is “no, the software loops back to step 140.

The words used in this application are words of description, and not words of limitation. Many variations and modifications will become apparent to those skilled in the art without departing from the scope and spirit of the invention as set forth in the appended claims.

We claim:

1. A method to determine the true ambient air temperature for the ambient air within the vicinity of any vehicle/equipment equipped with an engine having at least an ignition and an electronic control unit (ECU) with memory and a charge air cooler outlet temperature measurement, comprising:
determining whether ignition off period exceeds a calibratible predetermined period of time;
initializing ambient air temperature estimate based upon a last ambient air temperature value stored in memory from a last ignition off event;
determining charge air cooler cooler outlet value for a predetermined calibratible period of time;
comparing actual inlet air low temperature to last estimated inlet air ambient temperature over a predetermined calibratible period of time;
utilizing last estimated ambient air temperature as the ambient air temperature estimate if it is lower than the actual ambient air temperature;
increasing the ambient temperature estimate as a calibratible function of vehicle speed if the minimum charge air cooler outlet temperature value for a calibratible period of time is higher than the actual ambient air temperature.

2. The method of claim 1, wherein if the actual ambient air temperature is lower than the estimated ambient air temperature, both temperature values are passed through a low pass filter to determine an incremental rise to a useable ambient air temperature value.

3. The method of claim 1, wherein said actual ambient air temperature may be measured based upon intake manifold temperature, turbo compressor inlet temperature, or turbo compressor outlet temperature.

4. The method of claim 2, wherein said incremental rise in ambient air temperature of a useable ambient air temperature value is determined according to
y(n)=[1−filter constant]x(n)+filter constant Xy(n−1)

5. The method of claim 4, wherein said filter constant may be based upon vehicle speed to compensate for heat soaks.

6. The method of claim 5, wherein said vehicle speed is determined by measuring at least one of wheel speed, road speed, and transmission speed.
